(19) United States
(12) Patent Application Publication
(10) Pub. No.: US 2014/0188258 A1
(43) Pub. Date: Jul. 3, 2014

(54) MEDIA PLAYER AND INFORMATION UPDATING METHOD THEREOF

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/960,848

(22) Filed: Aug. 7, 2013

(30) Foreign Application Priority Data
Dec. 28, 2012 (CN) 2012105825603

(51) Int. Cl. G11B 20/10

(52) U.S. Cl. CPC G11B 20/10527
USPC 700/94

(57) ABSTRACT

A media player for playing audio files comprises storage, an obtaining module, a determining module, and a comparing module connected to the storage, the obtaining module, and the determining module. The storage is used for store breakpoint information which indicates the currently playing position of the playing audio file at a predetermined time period and comprises with a plurality of parameters. The obtaining module obtains breakpoint information. When there is previous stored breaking information in the storage, and any parameters of the current breakpoint information is different from the corresponding parameters of the previous stored breakpoint information in the storage, the comparing module controls the storage to replace the parameters of the previous stored breakpoint information with the corresponding different parameters of the current breakpoint information.

### BACKGROUND

1. Technical Field

The present disclosure relates to a media player.

2. Description of Related Art

Media players, such as a DVD player, store breakpoint information while playing audio file. The breakpoint information indicates a position where interruption of the playing media player occurs. However, the breakpoint information includes a large amount of data, such that storing the breakpoint information may affect the performance of the media player.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the media player and information updating method thereof. Moreover, in the drawings, like reference numerals designate corresponding parts throughout the several views.

FIG. 1 is a functional block of a media player in accordance with an embodiment.

FIG. 2 is a flowchart of an information updating method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

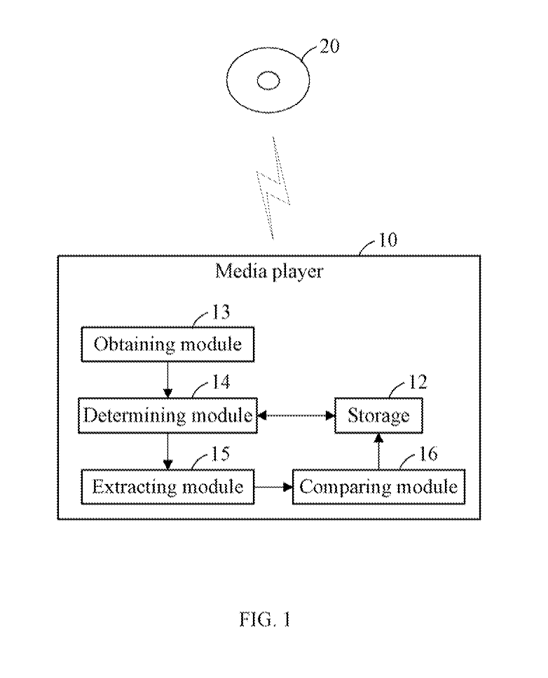

FIG. 1 shows a functional block of a media player 10 of an embodiment. The media player 10 updates breakpoint information at a predetermined time period while playing audio files. The breakpoint information indicates a current position of the playing audio file, and includes a number of parameters. In the embodiment, the media player 100 is a DVD player which reads and plays data from a disc 20. In other embodiments, the audio files can be a file on Internet or a file that is stored in the media player 10, the parameters can be disc indicating code, disc type, audio title, audio chapter, current playing time, and playing language, for example.

The media player 10 includes storage 12, an obtaining module 13, a determining module 14, an extracting module 15, and a comparing module 16.

The storage 12 is used for storing the breakpoint information and the parameters of the breakpoint information are stored in a predetermined order. In the embodiment, there is no breakpoint information in the storage 12 before the media player 10 plays the audio files.

The obtaining module 13 obtains current breakpoint information at a predetermined time period and generates a first determining signal while the media player 10 is playing the audio files. The predetermined time period can be set by operations of a user.

The determining module 14 determines whether there is breakpoint information in the storage 12 in response to the first determining signal. When there is no previous stored breakpoint information in the storage 12, the determining module 14 generates a storing signal; when there is previous stored breakpoint information in the storage 12, the determining module 14 generates an extracting signal.

The storage 12 stores the current breakpoint information in response to the storing signal.

The extracting module 15 extracts one parameter of the current breakpoint information according to the predetermined order in response to the extracting signal.

The comparing module 16 compares the extracted parameter of the current breakpoint information and the corresponding parameter of the previous stored breakpoint information in the storage 12. For example, the comparing module 15 compares the disc indicating code of the current breaking information and the previous stored disc indicating code in the storage 12. When the extracted parameter of the current breaking information is identical to the corresponding parameter of the previous stored breakpoint information in the storage 12, the comparing module 16 generates a second determining signal. When the extracted parameter of the current breaking information is different from the corresponding parameter of the previous stored breakpoint information in the storage 12, the comparing module 16 controls the storage 12 to replace the corresponding parameter of the previous stored breakpoint information with the extracted parameter of the current breaking information.

The determining module 14 further determines whether the extracted parameter is the last parameter of the current breakpoint information in response to the second determining signal. If the extracted parameter is not the last parameter of the current breakpoint information, the determining module 14 generates the extracting signal; if the extracted parameter is the last parameter of the current breakpoint information, the determining module 14 determines that the stored breakpoint information is completely updated.

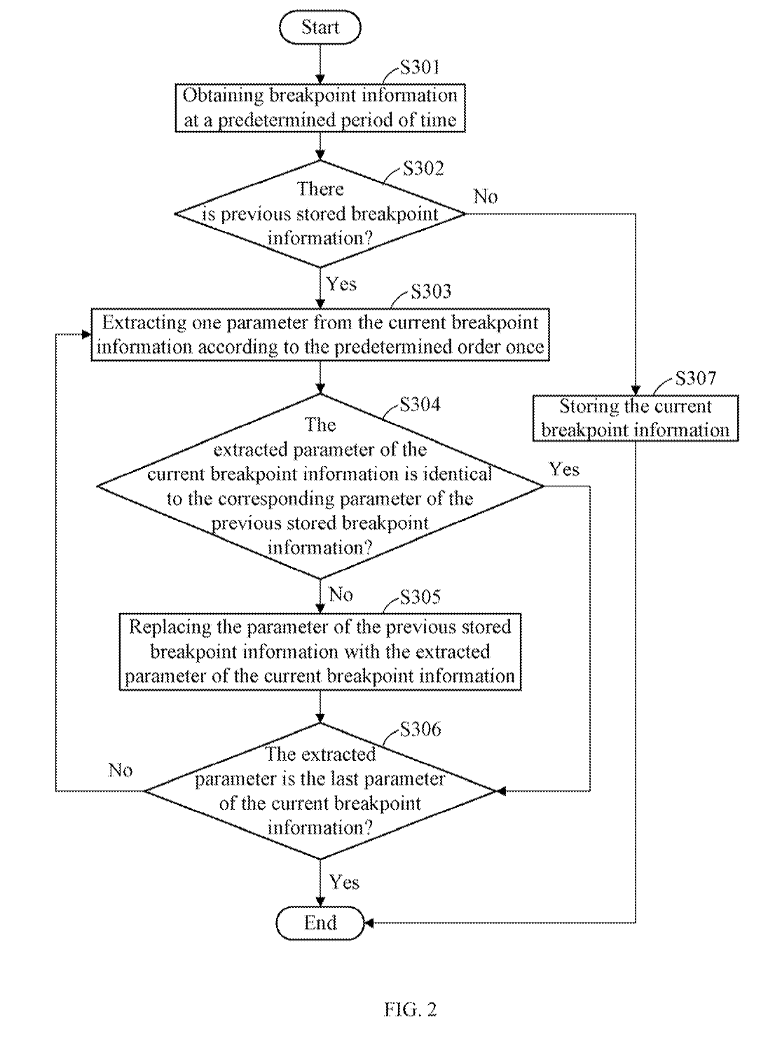

FIG. 2 shows that an information updating method for a media player to update breakpoint information for indicating the current playing position of the playing audio file. The breakpoint information includes a number of parameters. In the embodiment, the parameters can be disc indicating code, disc type, audio title, audio chapter, current playing time, and playing language, for example. The information storing method includes the following steps.

In step S301, the obtaining module 13 obtains breakpoint information at a predetermined time period. The predetermined time period can be set by operations of a user.

In step S302, the determining module 14 determines whether there is previous breakpoint information in the storage 12. If there is previous stored breakpoint information in the storage 12, the procedure goes to S303; if there is no previous stored breakpoint information in the storage 12, the procedure goes to S307.

In step S303, the extracting module 15 extracts one parameter of the current breakpoint information according to the predetermined order.

In step S304, the comparing module 16 compares the extracted parameter of the current breakpoint information and the corresponding parameter of the previous stored breakpoint information in the storage 12 correspondingly. If the extracted parameter of the current breakpoint information is different from the corresponding parameter of the previous stored breakpoint information, the procedure goes to S305; if the extracted parameter of the current breakpoint information is identical to the corresponding parameter of the previous stored breakpoint information, the procedure goes to S306.

In step S305, the storage 12 replaces the corresponding parameter of the previous stored breakpoint information with the extracted parameter of the current breakpoint information.

In step S306, the determining module 16 determines whether the extracted parameter is the last parameter of the current breakpoint information. If the extracted parameter is not the last parameter of the current breakpoint information, the, stored breakpoint information is not completely updated and the procedure goes to S303; if the extracted parameter is the last parameter of the current breakpoint information, the stored breakpoint information is completely updated and the procedure ends.

In step S307, the storage 12 stores the current breakpoint information.

By utilizing the present disclosure, the media player 100 only replaces the changing parameters of the previous stored breakpoint information, such that the amount of data needed to be stored is reduced and the affect is limited when playing the audio files.

While various exemplary embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A media player capable of playing audio files, the media player comprising:
a storage to store breakpoint information which indicates a current playing position of the playing audio file at a predetermined time period and comprises a plurality of parameters;
an obtaining module to obtain breakpoint information;
a determining module to determine whether there is previous stored breakpoint information in the storage; and
a comparing module connected to the storage, the obtaining module, and the determining module;
wherein when any parameter of the current breakpoint information is different from the corresponding parameter of the previous stored breakpoint information in the storage while the determining module determines that there is previous stored breakpoint information in the storage, the comparing module controls the storage to replace the parameters of the previous stored breakpoint information with the corresponding different parameters of the current breakpoint information.

2. The media player of claim 1, further comprising an extracting module; wherein when there is previous stored breakpoint in the storage, the determining module controls the extracting module to extract one parameter of the current breakpoint information according to a predetermined order, and the comparing module compares the extracted parameter of the current breakpoint information with the corresponding parameter of the previous stored breakpoint information.

3. The media player of claim 2, wherein the determining module determines whether the extracted parameter is the last parameter of the current breakpoint information, and controls the extracting module to extract one parameter when the extracted parameter is not the last parameter of the current breakpoint information.

4. The media player of claim 1, wherein when there is no previous stored breakpoint information in the storage, the determining module controls the storage to store the current breakpoint information.

5. The media player of claim 1, wherein the predetermined time period is set by operations of a user.

6. An information updating method for a media player to store breakpoint information which indicates a currently playing position of a playing audio file at a predetermined time period and comprises a plurality of parameters, the media player comprising a storage; the information storing method comprising:
obtaining the breakpoint information;
determining whether there is previous stored breakpoint information in the storage;
comparing the parameters of the current breakpoint information and the parameters of the previous stored breakpoint information in the storage correspondingly when there is previous stored breakpoint information in the storage; and
replacing the parameters of the previous stored breakpoint information with the corresponding different parameters of the current breakpoint information.

7. The method of claim 6, wherein the comparing step further comprises:
extracting one parameter of the current breakpoint information according to a predetermined order;
comparing the extracted parameter and the corresponding parameter of the previous stored breakpoint information in the storage; and
determining whether the extracted parameter is the last parameter of the current breakpoint information.

8. The method of claim 7, further comprising: storing the current breakpoint information when there is no previous stored breakpoint information in the storage.

9. The method of claim 6, wherein the predetermined time period is set by operations of a user.
